(19) United States
(12) Patent Application Publication
(10) Pub. No.: US 2016/0277929 A1
(43) Pub. Date: Sep. 22, 2016

(54) NETWORK ACCESS CONTROL

(71) Applicant: HANGZHOU H3C TECHNOLOGIES CO., LTD, Hangzhou, Zhenjiang (CN)

(72) Inventor: Jia LIU, Beijing (CN)

(73) Assignee: Hangzhou H3C Technologies Co., Ltd., Hangzhou City (CN)

(21) Appl. No.: 15/030,542

(22) PCT Filed: Oct. 21, 2014
(86) PCT No.: PCT/CN2014/089103

§ 371 Date: Apr. 19, 2016

(30) Foreign Application Priority Data
Oct. 25, 2013 (CN) 201310514171.1

(51) Int. Cl. H04W 12/06; H04W 48/16; H04L 29/06; H04L 29/08

(52) U.S. Cl. CPC H04W 12/06; H04L 67/16; H04W 48/16; H04L 69/324; H04L 63/0876; H04L 63/10; H04L 61/6022

(57) ABSTRACT

An access device receives a neighbor discovery protocol (NDP) packet sent from a user equipment (UE). The access device parses the NDP packet to obtain equipment information of the UE carried by the NDP packet. The access device transmits reporting message to a management server, wherein the reporting message carries the equipment information of the UE. Upon receiving a notification for identity authentication of the UE from the management server, the access device initiates an identity authentication invitation to the UE. The access device submits identity authentication information of the UE to the management server for authentication. The access device stores a first access control entry for the UE issued by the management server in its own data plane to control the UE's access to network resources after the identity authentication of the UE is permitted.

### BACKGROUND

In order to meet the needs that employees pursue new technology and personality, improve employee productivity, and reduce industry costs and investment, many industries consider permitting employees to bring their own user equipment to access a variety of network resources within the industries. This model is called as BYOD (Bring Your Own Device). The user equipment may be a Laptop computer, a cell phone, a Table PC, and so on.

### BRIEF DESCRIPTION OF DRAWINGS

Features of the present disclosure are illustrated by way of an example and not limited in the following figure(s), in which like numerals indicate like elements, in which:

FIG. 1 is an example of a diagram of a fundamental network architecture implementing network access control;

FIG. 2 is an example of a block diagram of an access device of the present disclosure;

FIG. 3 is an example of a block diagram of a management server of the present disclosure;

FIG. 4a is an example flowchart of a method of network access control on an access device;

FIG. 4b is an example flowchart of a method of network access control on a management server;

FIG. 5 is an example flowchart illustrating the procedures how the access device and the management server work together to implement network access control;

FIG. 6 is an example of a diagram showing a roaming event occurred in a network; and

FIG. 7 is an example flowchart showing network access control when a roaming event occurred in a network.

### DETAILED DESCRIPTION

For simplicity and illustrative purposes, a disclosure is described by referring mainly to an example thereof. In the following description, numerous specific details are set forth in order to provide a thorough understanding of the disclosure. It will be readily apparent however, that the disclosure may be practiced without limitation to these specific details. In other instances, some methods and structures have not been described in detail so as not to unnecessarily obscure the disclosure. As used herein, the terms “a” and “an” are intended to denote at least one of a particular element, the term “includes” means includes but not limited to, the term “including” means including but not limited to, and the term “based on” means based at least in part on.

The present disclosure provides a network access control solution, wherein this solution is able to control the User Equipment's (UE) access to network resources based on cooperation between the access device and the management server. For example, when an industry employee uses a Personal Tablet PC in his office position, this employee can use internal mail server, access to travel management page, and use online project management system, but the employee cannot access to confidential documents stored in an online shared directories. However, when the employee uses an office PC to work, he can access to the abovementioned confidential documents stored in the shared directories. This dynamic access control mechanism can permit industry to obtain better security experience.

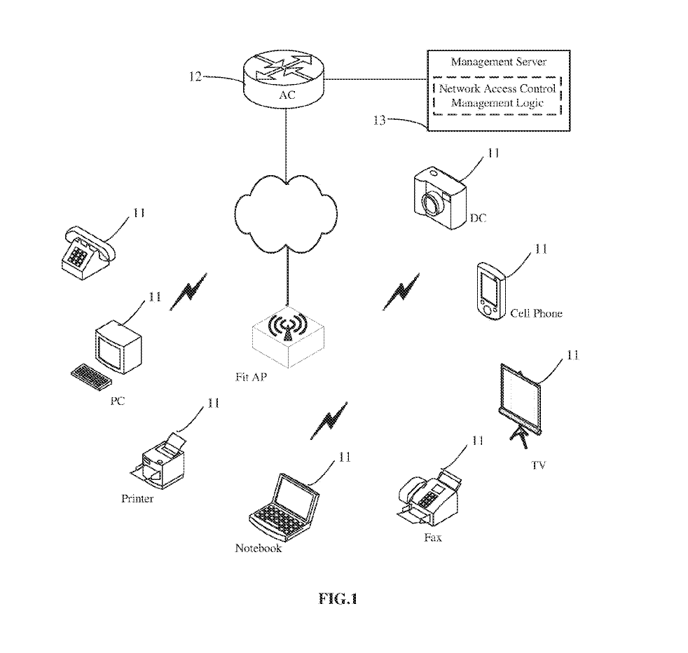

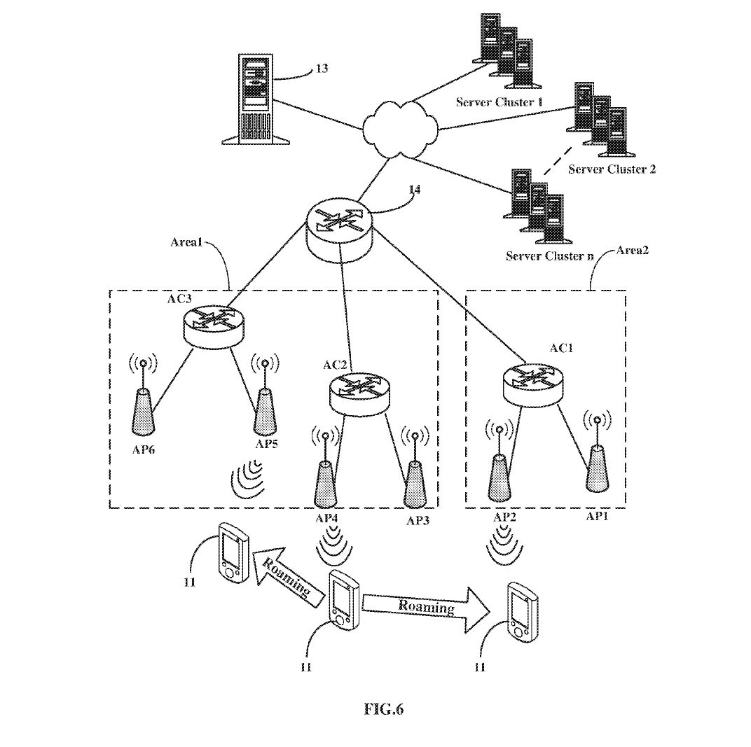

In an example, FIG. 1 is a diagram showing a fundamental network architecture implementing the network access control method. The network architecture shown in FIG. 1, for example, may include a user equipment 11, an wireless access device 12 and a management server 13. The network architecture may also include an aggregation network device 14 (such as a router, shown in FIG. 6), and n server clusters (including Server Cluster 1, . . . , and Server Cluster n shown in FIG. 6) configured with a variety of accessible network resources. The so-called network resources have a broad concept. It may include various network-based applications, such as abovementioned shared file services, web site services, online project management applications, internal mail services, travel management pages, and even a variety of network-based OA (Office Automation) applications, etc.

Please refer to FIG. 1, the UE 11, for example, can be a laptop Computer, a desktop computer or a cell phone. In other examples, the UE 11 can be a telephone, a printer, a fax, a TV, or a digital camera (DC), etc. The access device 12 can be a wireless access device, such as an access point (AP), an access controller (AC), or even a combination of AC and AP.

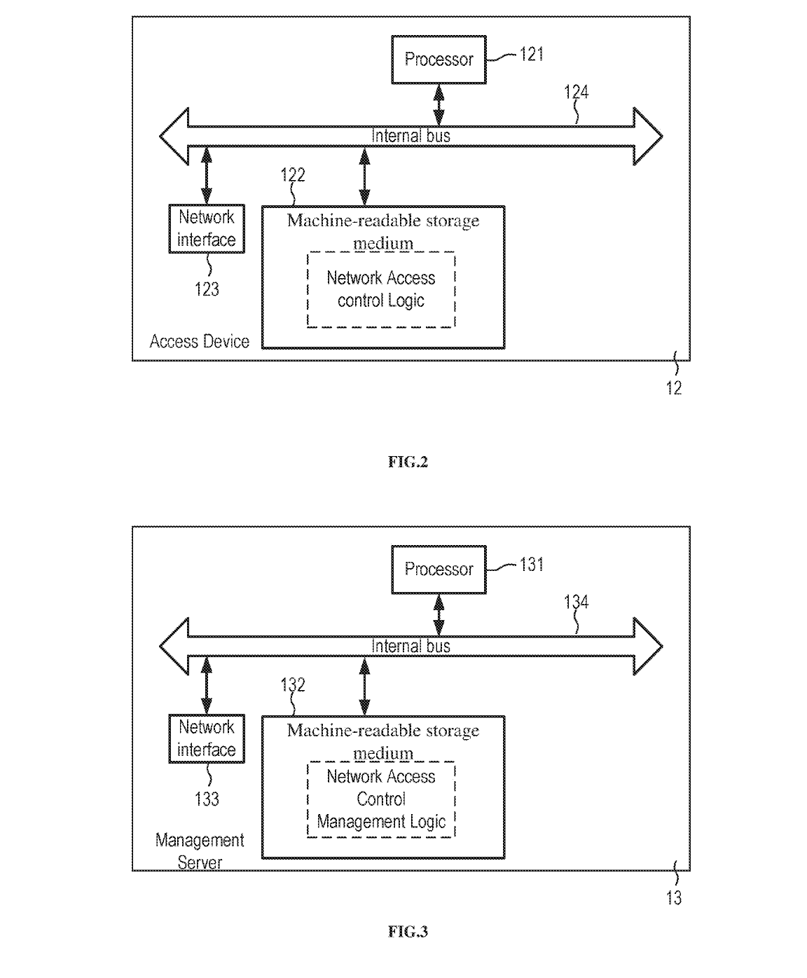

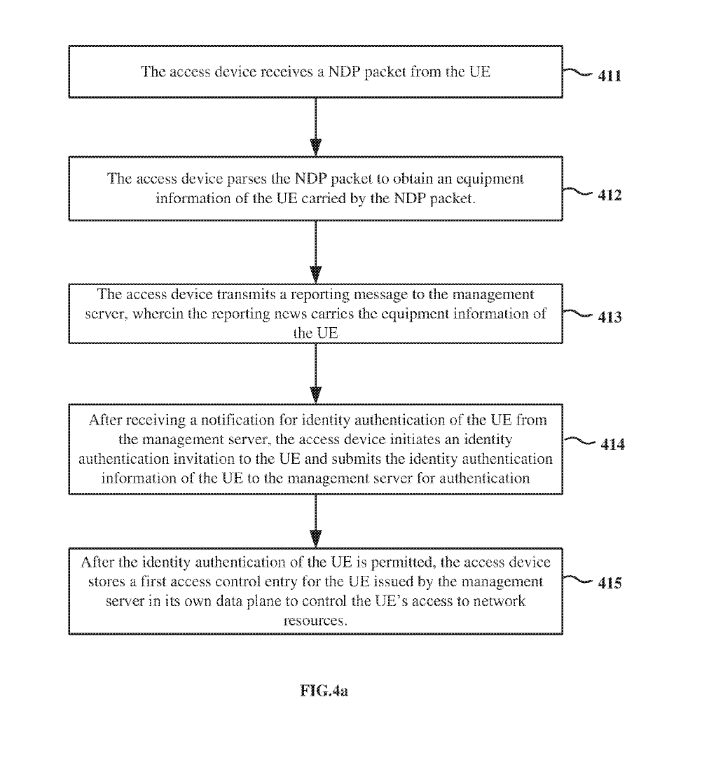

Please refer to FIG. 2. The access device 12, for example, may include a processor 121, a machine-readable storage medium 122, and a network interface 123, wherein the processor 121, the machine-readable storage medium 122, and the network interface 123 are coupled to each other through an internal bus 124. The processor 121 of the access device 12 may read computer instructions related to network access control logic from the machine-readable storage medium 122 and execute the computer instructions. Please refer to FIG. 3. The management server 13, for example, may include a processor 131, a machine-readable storage medium 132, and a network interface 133, wherein the processor 131, the machine-readable storage medium 132, and the network interface 133 are coupled to each other through an internal bus 134. The processor 131 of the management server 13 may read computer instructions related to network access control management logic and execute the computer instructions. The machine-readable storage medium may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory.

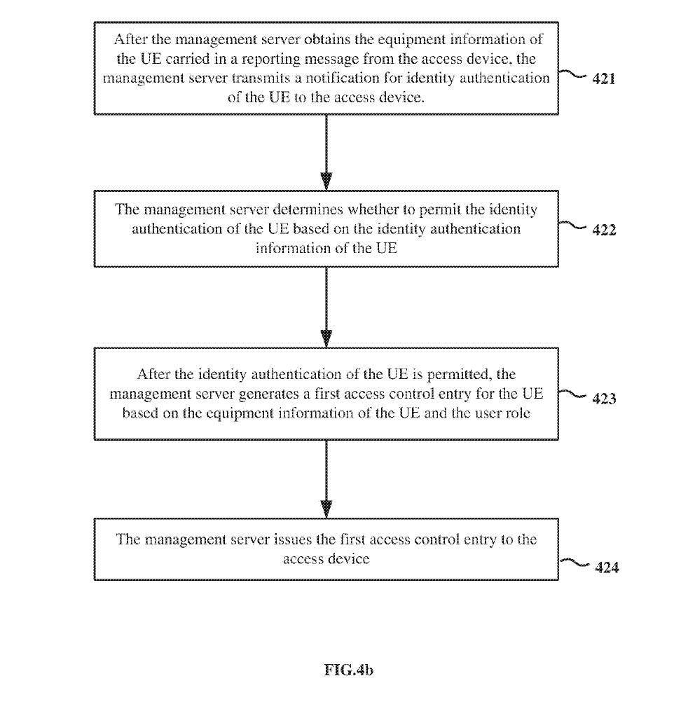

Please refer to FIG. 4a and FIG. 4b. The procedures how the network access control logic of the access device 12 and the network access control management logic of the management server 13 work together are described as below.

As shown in FIG. 4a, at block 411, the access device 12 receives a neighbour discovery protocol (NDP) packet from a user equipment (UE) 11.

At block 412, the access device 12 parses the NDP packet to obtain equipment information of the UE 11 carried by the NDP packet.

At block 413, the access device 12 transmits a reporting message to the management server 13, wherein the reporting message carries the equipment information of the UE 11.

At block 414, after receiving a notification for identity authentication of the UE 11 from the management server 13, the access device 12 initiates an identity authentication invitation to the UE 11 and submits the identity authentication information of the UE 11 to the management server 13 for authentication.

At block 415, after the identity authentication of the UE 11 is permitted, the access device 12 stores a first access control entry for the UE 11 issued by the management server 13 in its own data plane to control the UE's 11 access to network resources.

As shown in FIG. 4b, at block 421, after the management server 13 obtains the equipment information of the UE 11 carried in a reporting message from the access device 12, the management server 13 transmits a notification for identity authentication of the UE 11 to the access device 12.

At block 422, the management server 13 determines whether to permit the identity authentication of the UE 11 based on the identity authentication information of the UE 11.

At block 423, after the identity authentication of the UE 11 is permitted, the management server 13 generates a first access control entry for the UE 11 based on the equipment information of the UE 11 and the user role.

At block 424, the management server 13 issues the first access control entry to the access device 12.

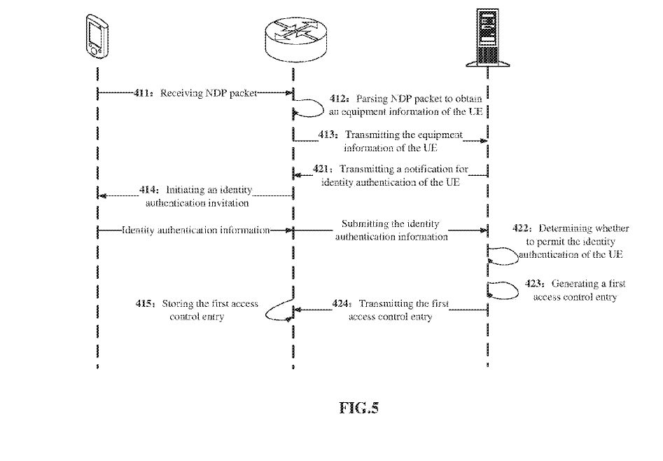

Please refer to FIG. 5, wherein FIG. 5 is a combination of the procedures shown in FIG. 4a and FIG. 4b. With reference to FIG. 5, a more detailed example is used for illustrating the procedures how the access device 12 and the management server 13 work together.

In an example, a wireless connection is built between the UE 11 and the Fit AP managed by the access device 12 (e.g., an AC), and preliminary network access work is completed after the authentication and association processes of the AC are completed. Before the block 411, the UE 11 may, for example, append its own equipment information to the NDP packet to the access device 12. In an example, the NDP packet can be a link layer discovery protocol (LLDP) packet or other similar protocol packets. Take the LLDP packet as an example, the UE 11 may write its own equipment information into the LLDP TLV, and then encapsulate the LLDP packet into 802.11 packet to be sent to the AP, such that the AP can transmit the packet through transparent CAPWAP tunnel to the AC. At blocks 411 and 412, the AC may parse the LLDP packet to obtain the equipment information of the UE 11 carried in the LLDP TLV.

Generally speaking, the equipment information of the UE 11 may include three types of information: software information of the UE 11, hardware information of the UE 11, and manufacturer information of the UE 11. Herein the software information may include software version information, and the software version information may include operating system (OS) version information (e.g., iOS 6.1.3) and may also include some application version information (e.g., IE 10). The hardware information may include hardware version information, such as baseband version information of a cell phone. It will be readily apparent however, that the equipment information of the UE 11 of the present disclosure is not limited to this only. In other instances, the equipment information of the UE 11 may still include the serial number of the UE 11, the module name of the UE 11, the asset identification word of the UE 11, and the like. The following description will take the OS version information of the UE, the hardware version information of the UE, and the manufacturer information of the UE as an example.

At block 413, the access device 12 carries the equipment information, obtained by parsing the packet, in the reporting message, and transmits the equipment information to the management server 13 via the connection between the management server 13. The type of the reporting message may be various predefined types, which should not be a limitation herein. At block 421, after the management server 13 obtains the equipment information of the UE 11, the management server 13 will issue an identity authentication of the UE 11. In an example, the management server 13 may issue the identity authentication right after the equipment information of the UE 11 is received. In another example, at block 421, before the notification for identity authentication is transmitted, the management server 13 may search the pre-configured rule management table (referring to the example of Table 1) based on the equipment information in advance; if the searched result is matched, then issue the identity authentication for the UE 11; if the searched result is not matched, then end processing. For example, according to the equipment information, it's found that the OS version of the UE is X2, the hardware version of the UE is Y2, and the manufacturer information is Z5, however, this combination does not exist in Table 1. This represents that Administrator does not want this UE to access corporate network resources, which may result in security issues. In other examples, there is no searching Table 1, the management server may immediately initiate identity authentication for the UE.

TABLE 1

| | OS | Hardware | | | |
|---|---|---|---|---|---|
| No. | Version | Version | Manufacturer | User Role | Access Rule |
| 1 | X1 | Y1 | Random | Visitors | Rule 1 |
| 2 | X1 | Y1 | Random | Levels 1-3 | Rule 2 |
| | | | | Employees | |
| 3 | X3 | Y3 | Random | Everyone | Rule 3 |
| . . . | . . . | . . . | . . . | . . . | . . . |
| n | X2 | Y2 | Z1 | Visitors | Rule n |
| n + 1 | X2 | Y2 | Z1 | All | Rule n + 1 |
| | | | | Employees | |
| . . . | . . . | . . . | . . . | . . . | . . . |

When the management server 13 determines to issue the identity authentication, the management server 13 transmits a notification for identity authentication to the access device 12. At block 414, after the access device 12 receives the notification for identity authentication, the access device 12 may initiate an identity authentication invitation to the UE 11. There are a variety of identity authentication methods, such as 802.1x or other similar identity authentication technologies. Take 802.1x as an example, the access device 12 may transmit EAP-Request packet to the UE 11 in order to issue a 802.1x authentication process. During the 802.1x authentication process, the access device 12 may act as a Proxy between the UE 11 and the management server 13, which may complete transmission of identity authentication information, such as user name and password, for assisting the UE 11 to successfully complete the authentication process. If the identity authentication information submitted by the UE 11 is illegal, for instance, wrong user name or wrong password, the identity authentication will fail. If the identity authentication information submitted by the UE 11 is legal, the management server 13 will determine the user role. At this time, the management server 13 may search a corresponding access rule by using the user equipment information and the user role, which is also called “security rule”.

Access rules define what network resources are accessible. According to an example, Table 2 shows concrete contents of access rules. As shown in Table 2, the Destination IP Address (DIP) and Protocol Type are used as characteristic elements of access rules. In Table 2, Rule 2 defines that: if a packet has the DIP Address belonging to this network segment 192.168.0.0/20, the access device 12 is permitted to be further processed, for example, forwarding process of the data packet can be continued. In other examples, more characteristic elements can be used in Table 2, such as packet source port or destination port, and so on.

TABLE 2

| Rule | DIP | Protocol Type | Action | . . . |
|---|---|---|---|---|
| Rule1 | 192.168.0.0/24 | Random | Permit | . . . |
| Rule2 | 192.168.0.0/20 | Random | Permit | . . . |
| . . . | . . . | . . . | . . . | . . . |

After the access rule is searched, the management server 13, for example, may control the UE's 11 access to network resources based on the searched access rule. In practice, the UE's 11 packet for accessing network resources must pass through its access device 12, rather than pass through the management server 13 itself. The management server 13 needs the access device 12 to achieve controls of accessing network resources for the UE 11. The management server 13 may generate a first access control entry based on the access rule and the identification of the UE 11, since the access rule is focused on the UE 11. After the access device 12 obtains the first access control entry, the access device 12 may store it in the access control table of its own data plane, which is used as the basis for processing the UE's packets. Please refer to Table 3, herein the user equipment identification can be, for example, MAC address of the UE, virtual local area network identification (VLAN ID), or other identifications in the packets transmitted by the UE 11. As can been seen from Table 3, each of the first access control entries may include a source MAC address (SMAC, i.e., the MAC address of the UE 11), a destination IP address, and Action. The type of the access control entry can be, for example, access control list (ACL) entry.

TABLE 3

| No. | SMAC | DIP | Protocol Type | Action |
|---|---|---|---|---|
| 1 | 00-00-00-00-00-12 | 192.168.0.0/24 | Random | Permit |
| 2 | 00-00-00-00-00-13 | 192.168.0.0/24 | Random | Permit |
| 3 | 00-00-00-00-00-14 | 192.168.0.0/20 | Random | Permit |
| . . . | . . . | . . . | . . . | . . . |

When the data plan of the access device 12 is processing the packets transmitted from the UE 11, the access device 12 may control the UE's 11 access to network resources based on its own access control table. When the packets transmitted from the UE 11 arrives, the access device 12 may obtain Source MAC address (i.e., the MAC address of the UE 11) and Destination IP address of the packets, and then match in the access control table (such as, Table 3). If any one entry is matched, the access device 12 may perform corresponding processes based on the actions in the entry. If the action in the entry is permitted, the access device 12 may perform further processing. Please refer to Table 3. As can be known from the 1st entry shown in Table 3: if the source MAC address of a packet is 00-00-00-00-00-12 and the destination IP address of this packet belongs to a network segment of 192.168.0.0/24, for instance, this packet is allowed to be further processed. If this packet is a data packet, the access device 12 may forward this packet based on an internal forwarding entry. Similarly, as can be known from the 3rd entry shown in Table 3: if the source MAC address of a packet is 00-00-00-00-00-14 and the destination IP address of this packet belongs to a network segment of 192.168.0.0/20, for instance, this packet is allowed to be further processed.

Please refer to Table 4, according to an example, the access device 12 may be pre-configured with two default entries with lower matching priority, such as the (n−1)th entry and the nth entry, respectively. Herein the matching priority of the nth entry is configured to be the lowest and the matching priority of the (n−1)th entry is configured to be the second lowest, and their matching priorities are lower than the matching priority of the first access control entry from the management server 13. The so-called matching priority means the priority that the data plane is matched in the access control table, wherein reasonable configured matching priorities may obtain expected processing effects. In an example, the (n−1)th entry and the nth entry may be automatically delivered to the data plane by the access device 12 during its start up. If a packet transmitted by the UE 11 cannot be matched to the previous (n−1) entries, this packet will be matched to the nth entry and the Action of this nth entry is “Drop”, and thus this packet will be discarded. Another word for speaking, if the management server 13 does not generate the first access control entry for the UE 11 and does not transmit it to the corresponding access device 12, unless LLDP packets and 802.1x identity authentication packets of the UE 11 can be matched to the (n−1)th entry to permit further processing, all other packets will be discarded, and thus the user cannot access any network resources before authentication is completed.

TABLE 4

| NO. | SMAC | DIP | Protocol Type | Action |
|---|---|---|---|---|
| 1 | 00-00-00-00-00-12 | 192.168.0.0/24 | Random | Permit |
| 2 | 00-00-00-00-00-13 | 192.168.0.0/24 | Random | Permit |
| 3 | 00-00-00-00-00-14 | 192.168.0.0/20 | Random | Permit |
| . . . | . . . | . . . | . . . | . . . |
| n − 1 | Random | Random | 802.1x | Permit |
| | | | LLDP | |
| n | Random | Random | Random | Drop |

Please refer to the 1st entry and the 2nd entry shown in Table 1, wherein the equipment information of these two entries are the same but their user roles are different, which results in different access rules (for example, the 1st entry corresponds to Rule 1 while the 2nd entry corresponds to Rule 2). Accordingly, the management server 13 may generate different first access control entries based on different access rules. Similarly, please refer to the 1st entry and the nth entry shown in Table 1, wherein the user roles of these two entries are the same but their equipment information are different, which may also result in different access rules, such that the management server 13 may generate different first access control entries to them.

Please refer to Table 1 in combination with Table 2. If the user equipment of two users are the same but their user roles are different, they may have different permissions to access network resources. According to an example, network resources in the network segment “192.168.0.0/24” can be some network resource that is allowed to be public to partners, such as some web sites of industry suppliers, some detailed requirements for introducing industry purchase, or some FTP sites allowing the partners to download related product/training documents. Such network resources can be randomly accessed by users with a visitor role, and such access behaviour won't cause trouble to information security of industry network. The network resources of the network segment “192.168.0.0/20” are obviously more than the network resources of the network segment “192.168.0.0/24”, and these additional network resources may not be allowed to be public to the users with a visitor role, such as industry's internal mail server, inquiry services for contacting staffs, and so on.

According to the examples described above, the management server 13 may search the corresponding access rule based on the equipment information and the user role shown in Table 1. According to other examples of the present disclosure, Table 1 may introduce more other information. Please refer to Table 5, the rule management table may further introduce the access device as the basis for searching the access rules. In an example, each entry of the rule management table can be configured with an access device cluster, wherein the content of the access device cluster may include one or more access device identifications. That is to say, one access rule may correspond to one or more access devices within the access device cluster. The access device identification may be an AC identification or an AP identification, wherein the identification itself can be MAC address. For example, as shown in the (n+1)th entry of Table 5, the access device cluster may include AC2 and AC3. Since each access device 12 is generally located at a fixed position, the management server 13 may determine the position of the access device based on the access device identification.

TABLE 5

| | OS | Hardware | | | Access Device | Access |
|---|---|---|---|---|---|---|
| No. | Version | Version | Manufacturer | User Role | Cluster | Rule |
| 1 | X1 | Y1 | Random | Visitors | Random | Rule 1 |
| 2 | X1 | Y1 | Random | Levels 1-3 | Random | Rule 2 |
| | | | | Employees | | |
| 3 | X3 | Y3 | Random | Everyone | Random | |
| | . . . | . . . | . . . | . . . | . . . | . . . |
| n | X2 | Y2 | Z1 | Visitors | | Rule n |
| n + 1 | X2 | Y2 | Z1 | All Employees | AC2 | Rule n + 1 |
| | | | | | AC3 | |
| n + 2 | X2 | Y2 | Z1 | All Employees | AC1 | Rule n + 2 |
| . . . | . . . | . . . | . . . | . . . | . . . | . . . |

In an example, assuming that AC2 is located at the guest reception area of an industry building, and AC1 is located at the office area. As shown in Table 5, the equipment information and the user roles of the (n+1)th entry and the (n+2)th entry are consistent, but their access devices AC are different, which may result in different access rules. In this example, the (n+1)th entry corresponds to Rule n+1 while the (n+2)th entry corresponds to Rule n+2. At this time, Table 5 can be evolved into the example in Table 6. The management server 13 may generate the ith access control entry based on Rule n+1, and then transmit it to the access device AC2. An employee “A” may use the UE (00-00-00-00-00-15) to access network resources of this network segment “192.168.0.0/22” when the access device is AC2. The management server 13 may generate the jth access control entry based on Rule n+2, and then transmit it to the access device AC1. The employee “A” may use the UE (00-00-00-00-00-15) to access network resources of this network segment “192.168.0.0/16” when the access device is AC1.

TABLE 6

| No. | SMAC | DIP | . . . | Action |
|---|---|---|---|---|
| 1 | 00-00-00-00-00-12 | 192.168.0.0/24 | . . . | Permit |
| 2 | 00-00-00-00-00-13 | 192.168.0.0/24 | . . . | Permit |
| 3 | 00-00-00-00-00-14 | 192.168.0.0/20 | . . . | Permit |
| . . . | . . . | . . . | . . . | . . . |
| i | 00-00-00-00-00-15 | 192.168.0.0/22 | . . . | Permit |
| j | 00-00-00-00-00-15 | 192.168.0.0/16 | . . . | Permit |
| . . . | . . . | . . . | . . . | . . . |

As can been seen from the abovementioned descriptions, even if the same user uses the same UE but uses different access devices to access network, they may get different permissions to access network resources. For example, if the user accesses network through AC1, the user may obtain the permission to access network resources of this network segment “192.168.0.0/16”; however, if the user accesses network through AC2, the user may obtain the permission to access network resource of another network segment “192.168.0.0/22”. The network resources of the network segment “192.168.0.0/16” are obviously more than the network resources of the network segment “192.168.0.0/22”, for example, internal mail server may be configured in this network segment “192.168.0.0/22”, but confidential documents sharing are not in the network segment “192.168.0.0/22”, while it's in the network segment “192.168.0.0/16” except “192.168.0.0/22”. This means, when the user accesses network in the guest reception area, the access to network resources are more restrictive; however, when the user uses the same UE to access network in the office area, the restrictions for accessing network resources become smaller. Such a design can obviously protect access security of industry internal network resources, which can avoid confidential information being leaked intentionally or unintentionally.

According to another example, Table 1 or Table 5 may further include access time as the basis for searching access rules. For example, in Table 1, if the same user uses the same UE to access network resources at different access times, the Administrator may configure different access rules to these conditions. For example, if one user accesses network before dawn, his access priority is more restrictive. It's easy to understand that: the time period before dawn is usually not a working time and s security issue should be concerned at this time, and thus the corresponding access rule won't permit the user to access confidential documents stored in some shared directories. In contrast, if the same user uses the same UE to access network in the daytime, it may correspond to another access rule, wherein the access rule will permit the user to access the abovementioned confidential documents stored in some shared directories.

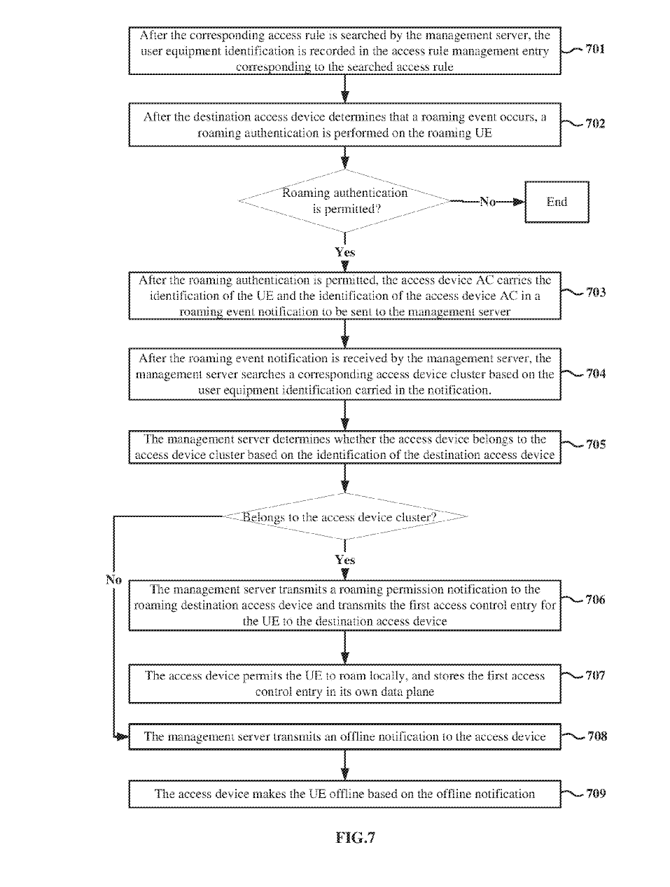

According to still another example, mobility features of the UE are taken into consideration, for example, the UE may roam from one access device to another access device. Please refer to FIG. 6. The network may, for example, include a first access device (such as, AC1), a second access device (such as, AC2), and a third access device (such as, AC3); wherein the first access device AC1 manages AP1 and AP2, the second access device AC2 manages AP3 and AP4, and the third access device AC3 manages AP5 and AP6. Herein the second access device AC2 and the third access device AC3 are located at Area 1 (such as, a guest reception area), while the first access device AC1 is located at Area 2 (such as, an office area). If the user carries the UE to be moved between various ACs, ACs will determine that a roaming event occurred. Please refer to FIG. 7. FIG. 7 is an example flowchart illustrating the procedures how the management server and the AC work together when a roaming event occurred in a network, which may include the following blocks.

At block 701, after the corresponding access rule is searched by the management server 13, the user equipment identification is recorded in the access rule management entry corresponding to the searched access rule.

At block 702, after the destination access device 12 determines that a roaming event occurs, a roaming authentication is performed on the roaming UE 11; if the roaming authentication is permitted, go to block 703; otherwise, end of process.

At block 703, after the roaming authentication is permitted, the access device AC carries the identification of the UE 11 and the identification of the access device AC in a roaming event notification to be sent to the management server 13.

At block 704, after the roaming event notification is received by the management server 13, the management server 13 searches a corresponding access device cluster based on the user equipment identification carried in the notification.

At block 705, the management server 13 determines whether the access device belongs to the access device cluster based on the identification of the destination access device; if yes, go to block 706; otherwise, go to block 708.

At block 706, the management server 13 transmits a roaming permission notification to the roaming destination access device and transmits the first access control entry for the UE to the destination access device.

At block 707, the access device permits the UE 11 to roam locally, and stores the first access control entry in its own data plane.

At block 708, the management server 13 transmits an offline notification to the access device 12.

At block 709, the access device 12 makes the UE 11 offline.

In an example, in order to process the roaming event, the management server 13 will record the identification of the UE 11 in the rule management table after the corresponding access rule is searched. In an example, after such a process, Table 5 can be evolved into the example in Table 7.

TABLE 7

| | | | | | Access | | |
|---|---|---|---|---|---|---|---|
| | OS | Hardware | | | Device | Access | |
| No. | Version | Version | Manufacturer | User Role | Cluster | Rule | UE |
| 1 | X1 | Y1 | Random | Visitors | Random | Rule 1 | 00-00-00-00-00-12 |
| | | | | | | | 00-00-00-00-00-13 |
| 2 | X1 | Y1 | Random | Levels 1-3 | Random | Rule 2 | 00-00-00-00-00-14 |
| | | | | Employees | | | |
| 3 | X3 | Y3 | Random | Everyone | Random | | . . . |
| | . . . | . . . | . . . | . . . | . . . | . . . | . . . |
| n | X2 | Y2 | Z1 | Visitors | | Rule n | . . . |
| n + 1 | X2 | Y2 | Z1 | All | AC2 | Rule | 00-00-00-00-00-15 |
| | | | | Employees | AC3 | n + 1 | |
| n + 2 | X2 | Y2 | Z1 | All | AC1 | Rule | 00-00-00-00-00-16 |
| | | | | Employees | | n + 2 | |
| . . . | . . . | . . . | . . . | . . . | . . . | . . . | . . . |

Please refer to FIG. 7 and Table 7. When the UE 11 roams from the source access device AC2 to the destination access device AC3, the destination access device AC3 will search whether the pairwise master key (PMK) information of the UE exists; if yes, AC3 will determine that the user roaming authentication is permitted; otherwise, AC3 will reject the roaming request from the UE 11. Assume that the roaming authentication of the UE 11 is permitted, at this time, the access device AC3 will transmit the roaming event notification to the management server 13, wherein the roaming event notification is mainly used to inform the management server 13 which UE 11 roams to the access device. The management server 13 may search Table 7 based on the user equipment identification (e.g., MAC address, 00-00-00-00-00-15) carried in the roaming notification. Since the UE 11 has already accessed the source access device AC2, the management server 13 has searched Rule n+1 and has generated the corresponding first access control entry to be sent to AC2. Hence, according to block 701, the management server 13 may record the user equipment identification in the (n+1)th entry. At this time, by using the user equipment identification to search Table 7, the (n+1)th entry can be matched so as to make sure that the corresponding access device clusters are AC2 and AC3. At this time, the management server 13 finds that the destination access device AC3 is within the access device cluster, which shows that the currently-used Rule n+1 for the AC2 can also be used on AC3. Therefore, the management server 13 transmits the roaming permission notification to AC3 and the first access control entry (such as, the ith entry shown in Table 5) generated for the UE 11 to AC3. After AC3 received the roaming permission notification, AC3 may permit the UE 11 to roam locally and store the first access control entry to its local data plane. As a result, after the UE 11 successfully roams, its permission for accessing network resources is not changed, wherein the entire process is transparent to the user, and it will not cause any security issues.

Please keep referring to FIG. 7 and Table 7. According to the previous example, the UE 11 roams from the source access device AC2 to the destination access device AC3, and the roaming behaviour of the UE 11 can be successful. In this example, assume that the UE 11 roams from the source access device AC2 to the destination access device AC1. At this time, the same procedures from block 701 to block 709 are executed. During the process, the management server 13 may search Table 7 based on the user equipment identification (e.g., MAC address, 00-00-00-00-00-15) carried in the roaming notification, and the (n+1)th entry can be matched so as to make sure that the corresponding access device clusters are still AC2 and AC3. At this time, the management server 13 finds that the destination access device AC1 is not within the access device cluster. That is to say, the management server 13 is temporarily unable to determine whether to transmit Rule n+1 to AC1 or not. At this time, the management server 13 may transmit an offline notification to AC1 for instructing AC1 to make the UE 11 offline. After AC1 receives the offline notification, AC1 will force the UE 11 offline. Certainly, the offline UE 11 may access to AC1 via AP1 or AP2, who are managed by AC1, again. At this time, the access device AC1 and the management server 13 will execute the blocks 411-415 and the blocks 421-424, respectively. It all procedures go well, the UE 11 can be successful on-line again. However, this time the access priority of the UE 11 may change, and its accessible network resources may be different from the previous accessible network resources when the UE 11 accessed to AC2. In addition to unsuccessful roaming will make the UE 11, the user may be offline on his own initiative. Besides, the management server 13 can also set a lifetime of the first access control entry for each UE. When the lifetime of the first access control entry expires, the management server 13 may transmit the offline notification to the corresponding access device to force the user offline. After the user is offline, the management server will remove internal response records.

The figures are only illustrations of an example, wherein the units or procedure shown in the figures are not necessarily essential for implementing the disclosure. The units in the device in the example can be arranged in the device in the examples as described, or can be alternatively located in one or more devices different from that in the examples. The units in the examples described can be combined into one module or further divided into a plurality of sub-units.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the disclosure.

Throughout the disclosure, the word “comprise”, or variations such as “comprises” or “comprising”, will be understood to imply the inclusion of a stated element, integer, block, or group of elements, integers, block, but not the exclusion of any other element, integer or block, or group of elements, integers or blocks.

Numerous variations and/or modifications may be made to the above-described embodiments, without departing from the broad general scope of the disclosure. The embodiments are, therefore, to be considered in all respects as illustrative and not restrictive.

1. A method of wireless network access control, comprising:
receiving, by an access device, a neighbor discovery protocol (NDP) packet sent from a user equipment (UE);
parsing, by the access device, the NDP packet to obtain an equipment information of the UE carried by the NDP packet;
transmitting, by the access device, a reporting message to a management server, wherein the reporting message carries the equipment information of the UE;
upon receiving a notification for identity authentication of the UE from the management server:
initiating, by the access device, an identity authentication invitation to the UE; and
submitting, by the access device, an identity authentication information of the UE to the management server for authentication; and
storing, by the access device, a first access control entry for the UE issued by the management server in its own data plane to control the UE's access to network resources after the identity authentication of the UE is permitted.

2. A method according to claim 1, wherein the equipment information comprises one or more of software information, hardware information, and manufacturer information.

3. A method according to claim 1, wherein the reporting message further carries a user equipment identification and an access device identification.

4. A method according to claim 1, wherein when determining that roaming event is occurred, performing a roaming authentication on a roaming UE; and when the roaming authentication is permitted, submitting a roaming event notification carrying an user equipment identification and an access device identification to the management server.

5. A method according to claim 1, wherein NDP packet comprises a link layer discovery protocol (LLDP) packet.

6. A method of wireless network access control management, comprising:
transmitting, by a management server, a notification for identity authentication of a user equipment (UE) to an access device, after obtaining an equipment information of the UE carried in a reporting message from the access device;
determining, by the management server, whether to permit the identity authentication of the UE based on the identity authentication information of the UE;
generating, by the management server, a first access control entry for the UE based on the equipment information of the UE and a user role, after the identity authentication of the UE is permitted; and
issuing, by the management server, the first access control entry to the access device.

7. A method according to claim 6, wherein the reporting message further carries a user equipment identification, and generating the first access control entry for the UE comprises:
searching a corresponding access rule in a predetermined rule management table based on the equipment information of the UE and the user role, and generating the first access control entry based on the searched access rule and the user equipment identification.

8. A method according to claim 7, wherein the reporting message further carries an access device identification, and generating the first access control entry for the UE comprises:
searching a corresponding access rule in a predetermined rule management table based on the equipment information of the UE, the access device identification, and the user role, and generating the first access control entry based on the searched access rule and the user equipment identification.

9. A method according to claim 8, wherein each entry of the rule management table further comprises an access device cluster, and the method further comprises:
recording, by the management server, the user equipment identification in an access rule entry after the corresponding access rule is searched;
searching, by the management server, a corresponding access device cluster based on the user equipment identification carried in a roaming event notification, after receiving the roaming event notification;
determining, by the management server, whether the access device belong to the access device cluster based on a destination access device identification;
if yes, submitting an permitted roaming notification to the access device, and submitting the first access control entry of the UE to the destination access device; and
if no, submitting an offline notification to the destination access device to ask the access device to make the ready-to-roaming UE offline.

10. A method according to claim 8, further comprising:
checking whether there is a matched entry in the rule management table based on the equipment information of the UE, before submitting a notification for identity authentication of the UE to the access device; and
if yes, determining that submitting the notification for identity authentication of the UE to the access device is necessary.

11. A access device for wireless network access control, comprising: a processor and a non-transitory storage medium storing machine-readable instructions those are executable by the processor to:
receive a neighbor discovery protocol (NDP) packet sent from a user equipment (UE);
parse the NDP packet to obtain an equipment information of the UE carried by the NDP packet;
transmit a reporting message to a management server, wherein the reporting message carries the equipment information of the UE;
upon receiving a notification for identity authentication of the UE from the management server, initiate an identity authentication invitation to the UE; and submit an identity authentication information of the UE to the management server for authentication; and
store a first access control entry for the UE issued by the management server in its own data plane to control the UE's access to network resources after the identity authentication of the UE is permitted.

12. The access device according to claim 11, wherein the equipment information comprises one or more of software information, hardware information, and manufacturer information.

13. The access device according to claim 11, wherein the reporting message further carries a user equipment identification and an access device identification.

14. The access device according to claim 11, wherein the machine readable instructions are further to cause the processor to:
when determining that roaming event is occurred, perform a roaming authentication on a roaming UE; and when the roaming authentication is permitted, submit a roaming event notification carrying an user equipment identification and an access device identification to the management server.

15. The access device according to claim 11, wherein NDP packet comprises a link layer discovery protocol (LLDP) packet.

16-20. (canceled)
